(19) United States
(12) Patent Application Publication
(10) Pub. No.: US 2021/0370556 A1
(43) Pub. Date: Dec. 2, 2021

(54) VEHICLE INTERIOR COMPONENT

(71) Applicant: Shanghai Yanfeng Jinqiao Automotive Trim Systems Co. Ltd., Novi, MI (US)

(72) Inventors: Werner Klusmeier, Lübbecke (DE); Peter Thielhorn, Muelheim/Ruhr (DE); Corinna Deyke, Neuss (DE); Benjamin Mehlau, Neuss (DE)

(21) Appl. No.: 17/403,363

(22) Filed: Aug. 16, 2021

Related U.S. Application Data
(63) Continuation of application No. PCT/US2020/018993, filed on Feb. 20, 2020.
(60) Provisional application No. 62/808,614, filed on Feb. 21, 2019.

(51) Int. Cl. B29C 43/18; B29C 43/20; B32B 27/12; B32B 27/32; B32B 27/36; B60R 13/02; B60N 2/75; B60N 2/56; B60H 1/22; H05B 3/18

(52) U.S. Cl. CPC B29C 43/18; B29C 43/203; B32B 27/12; B32B 27/32; B32B 27/36; B60R 13/0243; B29K 2023/12; B60N 2/75; B60N 2/5678; B60H 1/2227; H05B 3/18; B29C 2043/182; B60R 13/0256

(57) ABSTRACT

A vehicle interior component with a heater/heating element is disclosed. The component may comprise an assembly with the heating element produced in a mold tool by a process comprising assembling the heating element between a cover layer and a fiber layer to provide a pre-form assembly; consolidating the pre-form assembly (e.g. including trimming/compressing and/or heating); forming the pre-form assembly in the mold tool into a compression-formed body with a shape; applying a cover to the compression-formed body to provide a compression-formed panel. The compression-formed panel may be provided with the shape and an external surface provided by the cover. The texture/feel at the external surface of the compression-formed panel for the component may obscure the presence of the heating element within the component. The component may comprise a console; floor console; tunnel console; armrest; instrument panel; door; door panel; trim component; or panel.

### CROSS-REFERENCE TO RELATED APPLICATIONS

The present application is a continuation of PCT/International Patent Application No. PCT/US2020/018993 titled “VEHICLE INTERIOR COMPONENT” filed Feb. 20, 2020, which claims the benefit of U.S. Provisional Patent Application No. 62/808,614 titled “VEHICLE INTERIOR COMPONENT” filed Feb. 21, 2019.

The present application claims priority to and incorporates by reference in full the following patent application(s): (a) U.S. Provisional Patent Application No. 62/808,614 titled “VEHICLE INTERIOR COMPONENT” filed Feb. 21, 2019; (b) PCT/International Patent Application No. PCT/US2020/018993 titled “VEHICLE INTERIOR COMPONENT” filed Feb. 20, 2020.

### FIELD

The present invention relates to a vehicle interior component.

The present invention also relates to vehicle interior component with a heating element prepared by a process comprising the step of compression forming an assembly.

### BACKGROUND

It is known to provide a vehicle interior component assembly comprising a heating element.

It would be advantageous to provide an improved vehicle interior component with a heating element. It would also be advantageous to provide a vehicle interior component comprising a heating element comprising a structural layer and a cover with an external surface comprising reduced variation in texture/profile at the external surface notwithstanding the heating element contained within the component.

### SUMMARY

The present invention relates to a vehicle interior component assembly comprising a heating element produced in a mold tool by a process comprising the steps of assembling the heating element between a cover layer and a fiber layer to provide a pre-form assembly, consolidating the pre-form assembly, placing the pre-form assembly into the mold tool, forming the pre-form assembly into a compression-formed body with a shape and applying a cover to the compression-formed body to provide a compression-formed panel so that the compression-formed panel is provided with the shape and an external surface provided by the cover. The mold tool may comprise a surface; the external surface of the compression-formed panel may be at least partially provided by the surface of the mold tool. The step of consolidating the pre-form assembly may comprise at least one of (a) securing the heating element between the cover layer and the fiber layer with adhesive; (b) merging the cover layer, the heating element and the fiber layer; (c) fusing the cover layer, the heating element and the fiber layer; (d) shaping the cover layer, the heating element and the fiber layer; (e) cutting the cover layer, the heating element and the fiber layer to size; (f) heating the cover layer, the heating element and/or the fiber layer. The cover layer may be configured for application of the cover so that the cover is secured to the cover layer to provide the compression-formed panel with the external surface. The external surface of the cover of the compression-formed panel may be configured to provide a texture provided by the cover and the cover layer. The fiber layer of the pre-form assembly may comprise a structural layer; the structural layer may comprise natural fibers and a resin; the cover layer may comprise polypropylene and polyester. The fiber layer may comprise at least one of (a) a panel; (b) a mat; (c) a batt; (d) a fiber panel; (e) a fiber mat; (f) a fiber batt; (g) a natural fiber material; (h) a polypropylene material; (i) a natural fiber and polypropylene mat; (j) a mat formed from natural fibers and polypropylene fibers. The cover layer for the pre-form assembly may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet.

The present invention relates to a component comprising an external surface for a vehicle interior comprising a panel assembly and a cover configured to provide the external surface; the panel assembly may comprise a structural layer, a heater over the structural layer and a top layer between the heater and the cover. The top layer may be configured to provide the external surface for the component comprising reduced variation. The top layer may comprise an outer surface facing the cover with a smooth texture and the structural layer may comprise an outer surface facing the heater with a rough texture. The top layer may be configured to provide improved profile tolerance for the component. The top layer may be configured to reduce variation in profile for the component. The top layer may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The structural layer may comprise natural fibers and a resin; the top layer may comprise polypropylene and polyester. The structural layer may comprise at least one of (a) a panel; (b) a mat; (c) a batt; (d) a fiber panel; (e) a fiber mat; (f) a fiber batt. The cover may comprise at least one of (a) leather; (b) artificial leather; (c) woven fabric; (d) non-woven fabric; (e) an applique; (f) vinyl; (g) foil. The heater may comprise a substrate and a wire coupled to the substrate of the heater; the substrate of the heater may comprise polypropylene fibers; the polypropylene fibers may be bonded to at least one of (a) the top layer; (b) the structural layer. The component may be produced by a process comprising the steps of assembling the heater between the top layer and the structural layer to provide a pre-form assembly, consolidating the pre-form assembly, placing the pre-form assembly into a mold tool, forming the pre-form assembly into a compression-formed body with a shape and applying the cover to the compression-formed body to provide a compression-formed panel so that the compression-formed panel is provided with the shape and an external surface provided by the cover.

The present invention relates to a vehicle interior component assembly comprising a heating element produced in a mold tool by a process comprising the steps of assembling the heating element between a cover layer and a fiber layer, consolidating the heating element, the cover layer and the fiber layer to provide a pre-form assembly by at least partially compressing the cover layer and the heating element and the fiber layer, placing the pre-form assembly into the mold tool, forming the pre-form assembly into a compression-formed body with a shape and applying a cover to the compression-formed body to provide a compression-formed panel so that the compression-formed panel is provided with the shape and an external surface provided by the cover.

The present invention relates to a component for a vehicle interior comprising a panel assembly and a cover; the panel assembly may comprise a top layer, a heater and a structural layer. The top layer may comprise an outer surface with a smooth texture and the structural layer may comprise an outer surface with a rough texture. The top layer may be configured to provide improved profile tolerance for the component. The top layer may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The structural layer may comprise natural fibers and a resin; the top layer may comprise polypropylene and polyester. The resin may comprise polypropylene and the natural fibers comprise at least one of (a) flax; (b) kenaf. The structural layer may comprise at least one of (a) a panel; (b) a mat; (c) a batt; (d) a fiber panel; (e) a fiber mat; (f) a fiber batt. The cover may comprise at least one of (a) leather; (b) artificial leather; (c) woven fabric; (d) non-woven fabric; (e) an applique; (f) vinyl; (g) foil. The heater may comprise a substrate and a wire coupled to the substrate of the heater; the substrate of the heater may comprise polypropylene fibers. The polypropylene fibers may be bonded to at least one of (a) the top layer; (b) the structural layer. The component may comprise at least one of (a) a console; (b) a floor console; (c) a tunnel console; (d) an armrest; (e) an instrument panel; (f) a door; (g) a door panel; (h) a trim component; (i) a panel. The component may be produced by a process comprising the steps of assembling the heater with a fiber layer to provide a pre-form assembly; consolidating the pre-form assembly; placing the pre-form assembly into a mold tool; forming the pre-form assembly into a compression-formed body with a shape; applying the cover to the compression-formed body to provide a compression-formed panel; so that the compression-formed panel is provided with the shape and an external surface. The component may be produced by a process comprising the steps of assembling the heater between the top layer and the structural layer to provide a pre-form assembly; consolidating the pre-form assembly; placing the pre-form assembly into a mold tool; forming the pre-form assembly into a compression-formed body with a shape; applying the cover to the compression-formed body to provide a compression-formed panel; so that the compression-formed panel is provided with the shape and an external surface provided by the cover.

The present invention relates to a vehicle interior component comprising a heating element produced in a mold tool by a process comprising the steps of assembling the heating element with a fiber layer to provide a pre-form assembly; consolidating the pre-form assembly; placing the pre-form assembly into the mold tool; forming the pre-form assembly into a compression-formed body with a shape; applying a cover to the compression-formed body to provide a compression-formed panel; so that the compression-formed panel is provided with the shape and an external surface. The fiber layer may comprise a structural layer for the pre-form assembly. The fiber layer may comprise at least one of (a) a panel; (b) a mat; (c) a batt; (d) a fiber panel; (e) a fiber mat; (f) a fiber batt; (g) a natural fiber material; (h) a polypropylene material; (i) a natural fiber and polypropylene mat; (j) a mat formed from natural fibers and polypropylene fibers. The step of forming the pre-form assembly into the compression-formed body may comprise compressing the pre-form assembly in the mold tool. The step of forming the pre-form assembly into a compression-formed body may comprise compressing the fiber layer with the heating element in the mold tool. The external surface of the compression-formed panel may comprise a texture provided by the cover. The mold tool may comprise a mold cavity with a surface; the external surface of the compression-formed panel may comprise a texture at least partially formed by the surface of the mold tool. The external surface of the compression-formed panel may comprise a texture provided by the cover and at least partially by the surface of the mold tool. The mold tool may comprise a mold cavity with a shape; the shape of the compression-formed panel may be at least partially provided by the shape of the mold tool. The mold tool may comprise a textured surface; the step of forming the pre-form assembly into the compression-formed body may comprise compressing the fiber layer with the heating element and at least partially forming the textured surface on the compression-formed body. The textured surface may be at least partially formed on the external surface of the compression-formed panel. The process may comprise the step of applying a cover layer for the pre-form assembly. The cover layer for the pre-form assembly may comprise at least one of a fiber layer or a fabric layer. The cover layer for the pre-form assembly may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The fiber layer of the pre-form assembly may comprise a structural layer; the structural layer may comprise natural fibers and a resin; the cover layer may comprise polypropylene and polyester. The step of assembling the heating element with the fiber layer may comprise assembling the heating element with the fiber layer with a cover layer to provide the pre-form assembly; the step of consolidating the pre-form assembly may comprise consolidating the fiber layer with the heating element and the cover layer. The step of forming the pre-form assembly into a compression-formed body with a shape may comprise compressing the fiber layer with the heating element and the cover layer to form the compression-formed body. The mold tool may comprise a textured surface; compressing the fiber layer with the heating element with the cover layer in the mold tool may comprise at least partially forming the textured surface on the cover layer of the compression-formed body. The step of consolidating the pre-form assembly may comprise at least one of (a) shaping the pre-form assembly; (b) heating the pre-form assembly. The process may comprise the steps of shaping the pre-form assembly and trimming the pre-form assembly. The step of forming the pre-form assembly into the compression-formed body may comprise compression of the pre-form assembly into the shape. The step of forming the pre-form assembly into the compression-formed body may comprise application of heat to form the compression-formed body into the shape. The shape may comprise at least one of (a) a contoured shape; (b) a formed shape. The cover may comprise at least one of (a) a film; (b) a fabric; (c) a sheet; (d) a coating; (e) paint; (f) a surface texture.

The present invention relates to a vehicle interior component assembly comprising a heating element produced in a mold tool by a process comprising the steps of assembling the heating element between a cover layer and a fiber layer to provide a pre-form assembly; consolidating the pre-form assembly; placing the pre-form assembly into the mold tool; forming the pre-form assembly into a compression-formed body with a shape; applying a cover to the compression-formed body to provide a compression-formed panel; so that the compression-formed panel is provided with the shape and an external surface provided by the cover. The mold tool may comprise a surface; the external surface of the compression-formed panel may be at least partially provided by the surface of the mold tool. The step of consolidating the pre-form assembly may comprise at least partially compressing the cover layer and the heating element and the fiber layer. The step of consolidating the pre-form assembly may comprise at least one of (a) securing the heating element between the cover layer and the fiber layer with adhesive; (b) merging the cover layer, the heating element and the fiber layer; (c) fusing the cover layer, the heating element and the fiber layer; (d) shaping the cover layer, the heating element and the fiber layer; (e) cutting the cover layer, the heating element and the fiber layer to size; (f) heating the cover layer, the heating element and/or the fiber layer. The cover layer may be configured for application of the cover; so that the cover is secured to the cover layer to provide the compression-formed panel with the external surface. The external surface of the cover of the compression-formed panel may be configured to provide a texture provided by the cover and the cover layer. The fiber layer of the pre-form assembly may comprise a structural layer; the structural layer may comprise natural fibers and a resin; the cover layer may comprise polypropylene and polyester. The fiber layer may comprise at least one of (a) a panel; (b) a mat; (c) a batt; (d) a fiber panel; (e) a fiber mat; (f) a fiber batt; (g) a natural fiber material; (h) a polypropylene material; (i) a natural fiber and polypropylene mat; (j) a mat formed from natural fibers and polypropylene fibers; the cover layer for the pre-form assembly may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet; the cover may comprise at least one of (a) a film; (b) a fabric; (c) a sheet; (d) a coating; (e) paint.

The present invention relates to a vehicle interior component assembly comprising a heating element in a compression-formed body having a shape produced in a mold tool comprising a first surface and a second surface by a process comprising the steps of placing the heating element on a fiber layer; placing the fiber layer into the mold tool; and compressing the fiber layer with the heating element between the first surface of the mold tool and the second surface of the mold tool to form the compression-formed body with the heating element and the shape. The process may comprise the step of providing a pre-form assembly comprising the fiber layer as a base for the heating element and a fabric layer over the heating element. The pre-form assembly may comprise a panel assembly. The process may comprise the step of heating the pre-form assembly and the step of trimming the panel assembly. The step of compressing the fiber layer may comprise compressing the pre-form assembly into the compression-formed body with the shape. The fiber layer may comprise at least one of (a) a panel; (b) a mat; (c) a batt; (d) a fiber panel; (e) a fiber mat; (f) a fiber batt. The mold tool may comprise a textured surface and the compression-formed body may be formed with a textured surface. The heating element may be encapsulated in the compression-formed body; the heating element may comprise an electric heating element. The process may comprise the step of placing a fabric sheet on the heating element so that the heating element is between the fiber layer and the fabric sheet. The compression-formed body may comprise a formed panel assembly; the formed panel assembly may comprise the heating element and a structural layer; an inner surface of the heater may be coupled to an outer surface of the structural layer. The formed panel assembly may comprise a top layer coupled to an outer surface of the heating element; the top layer may comprise an outer surface with a smooth texture; the outer surface of the structural layer may comprise a rough texture. The top layer may be configured to provide improved profile tolerance for the vehicle interior component assembly. The structural layer may comprise natural fibers and a resin and the top layer may comprise polypropylene and polyester. The resin may comprise polypropylene and the natural fibers comprise at least one of (a) flax; (b) kenaf. The top layer may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The process may comprise the steps of activating the top layer of the panel assembly and adhering a cover to the top layer of the panel assembly. The process may comprise the step of consolidating a top layer and the heating element and a structural layer to form the formed panel assembly before formation of the compression-formed body; the structural layer may comprise the fiber layer and the top layer may comprise a fabric panel. The process may comprise the step of consolidating the heating element and a structural layer to form a panel assembly. The process may comprise the step of heating the panel assembly; the panel assembly may be compressed as the panel assembly cools. The process may comprise the step of injecting resin into the mold tool after a compression formed component is formed to form an ancillary component of the vehicle interior component assembly. The process may comprise the step of disposing a cover onto the compression formed body to form the vehicle interior component assembly. The component assembly may comprise at least one of (a) a console; (b) a floor console; (c) a tunnel console; (d) an armrest; (e) an instrument panel; (f) a door; (g) a door panel; (h) a trim component; (i) a panel.

The present invention relates to a vehicle interior component assembly comprising a subsystem element in a compression-formed body having a shape produced in a mold tool comprising a first surface and a second surface by a process comprising the steps of placing the subsystem element on a bottom layer; placing a top layer on the bottom layer with the subsystem element to provide a pre-form assembly; placing the pre-form assembly into the mold tool; and compressing the pre-form assembly between the first surface of the mold tool and a second surface of the mold tool to form the compression-formed body with the subsystem element and the shape. The subsystem element may comprise a component configured to be electrified; the subsystem element may be at least partially concealed within the compression-formed body. The compression-formed body may comprise a structural element and the subsystem element. The compression-formed body may comprise the subsystem element concealed between the top layer and the bottom layer. The top layer may comprise a panel and the bottom layer may comprise a structural element. The structural element may comprise a panel. The panel of the structural element may comprise a fiber batt. The bottom layer may comprise a fiber mat and the top layer may comprise a fabric panel. The subsystem element may comprise a heating element; the heating element may comprise an electric resistance heating element. The component assembly may comprise a cover for the compression-formed body; the cover may comprise a surface texture. The cover may comprise at least one of (a) a film; (b) a fabric; (c) a sheet; (d) a coating; (e) paint. The process may comprise the step of providing the bottom layer as a fiber layer. The process may comprise the step of applying an adhesive for the subsystem element. The process may comprise the step of applying a fabric layer. The process may comprise the step of applying a cover to the compression-formed body. The compression-formed body may be formed as a panel.

The present invention relates to a vehicle interior component assembly comprising a heating element in a compression-formed body having a shape produced in a mold tool comprising a first surface and a second surface by a process comprising the steps of: placing the heating element on a fiber layer; placing the fiber layer into the mold tool and compressing the fiber layer with the heating element between the first surface of the mold tool and the second surface of the mold tool to form the compression-formed body with the heating element and the shape. The process may comprise the step of providing a pre-form assembly comprising the fiber layer as a base for the heating element and a fabric layer over the heating element. The pre-form assembly may comprise a panel assembly. The process may comprise the step of trimming the panel assembly. The process may comprise the step of heating the pre-form assembly. The step of compressing the fiber layer may comprise compressing the pre-form assembly into the compression-formed body with the shape. The fiber layer may comprise at least one of (a) a panel; (b) a mat; (c) a batt; (d) a fiber panel; (e) a fiber mat; (f) a fiber batt. The mold tool may comprise a textured surface and the compression-formed body may be formed with a textured surface. The heating element may be encapsulated in the compression-formed body. The heating element may comprise an electric heating element. The process may comprise the step of placing a fabric sheet on the heating element so that the heating element is between the fiber layer and the fabric sheet. The compression-formed body may comprise a formed panel assembly. The panel assembly may comprise the heating element and a structural layer; an inner surface of the heater may be coupled to an outer surface of the structural layer. The panel assembly may comprise a top layer coupled to an outer surface of the heating element. The top layer may comprise an outer surface with a smooth texture; the outer surface of the structural layer may comprise a rough texture. The top layer may be configured to provide improved profile tolerance for the vehicle interior component assembly. The structural layer may comprise natural fibers and a resin and the top layer may comprise polypropylene and polyester. The resin may comprise polypropylene and the natural fibers may comprise at least one of (a) flax; (b) kenaf. The top layer may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The top layer may comprise an area weight of between 200 grams per square meter and 300 grams per square meter. The process may comprise the steps of activating the top layer of the panel assembly and adhering a cover to the top layer of the panel assembly. The process may comprise the step of consolidating a top layer and the heating element and a structural layer to form the panel assembly before formation of the compression-formed body. The structural layer may comprise the fiber layer and the top layer may comprise a fabric panel. The process may comprise the step of consolidating the heating element and a structural layer to form a panel assembly. The panel assembly may comprise an area weight of between 1000 grams per square meter and 1800 grams per square meter. The panel assembly may comprise a thickness of between 1.5 millimeters and 4 millimeters. The process may comprise the step of heating the panel assembly; the panel assembly may be compressed as the panel assembly cools. The process may comprise the step of injecting resin into the mold tool after a compression formed component is formed to form an ancillary component of the vehicle interior component assembly. The process may comprise the step of disposing a cover onto the compression formed body to form the vehicle interior component assembly.

The present invention relates to a vehicle interior component assembly comprising a subsystem element in a compression-formed body having a shape produced in a mold tool comprising a first surface and a second surface by a process comprising the steps of placing the subsystem element on a bottom layer; placing a top layer on the bottom layer with the subsystem element to provide a pre-form assembly; placing the pre-form assembly into the mold tool; and compressing the pre-form assembly between the first surface of the mold tool and a second surface of the mold tool to form the compression-formed body with the subsystem element and the shape. The subsystem element may comprise a component configured to be electrified. The subsystem element may be at least partially concealed within the compression-formed body. The compression-formed body may comprise a structural element. The compression-formed body may comprise the subsystem element and the structural element. The compression-formed body may comprise the subsystem element concealed between the top layer and the bottom layer. The top layer may comprise a panel and the bottom layer may comprise a structural element. The structural element may comprise a panel. The panel may comprise a fiber batt. The bottom layer may comprise a fiber mat and the top layer may comprise a fabric panel. The bottom layer may comprise a fiber mat. The subsystem element may comprise a heating element. The heating element may comprise an electric heating element. The electric heating element may comprise an electric resistance heating element. The component assembly may comprise a cover for the compression-formed body. The cover may comprise a surface texture. The cover may comprise at least one of (a) a film; (b) a fabric; (c) a sheet; (d) a coating; (e) paint. The process may comprise the step of providing the bottom layer as a fiber layer. The process may comprise the step of applying an adhesive for the subsystem element. The process may comprise the step of applying a fabric layer. The process may comprise the step of applying a cover to the compression-formed body. The compression-formed body may be formed as a panel.

The present invention relates to a component for a vehicle interior comprising a panel assembly and a cover; the panel assembly may comprise a top layer, a heater and a structural layer. The top layer may comprise an outer surface with a smooth texture and the structural layer may comprise an outer surface with a rough texture. The top layer may be configured to provide improved profile tolerance for the component. The structural layer may comprise natural fibers and a resin; the top layer may comprise polypropylene and polyester. The resin may comprise polypropylene and the natural fibers comprise at least one of (a) flax; (b) kenaf. The cover may comprise at least one of (a) leather; (b) artificial leather. The cover may comprise at least one of (a) woven fabric; (b) non-woven fabric; (c) an applique; (d) vinyl; (e) foil. The heater may comprise a substrate and a wire coupled to the substrate of the heater. The substrate of the heater may comprise polypropylene fibers. The polypropylene fibers may be bonded to at least one of (a) the top layer; (b) the structural layer.

The present invention relates to a vehicle interior component assembly comprising a heating element in a compression-formed body having a shape produced in a mold tool comprising a first surface and a second surface by a process comprising the steps of placing the heating element on a fiber layer; placing the fiber layer into the mold tool; and compressing the fiber layer with the heating element between the first surface of the mold tool and the second surface of the mold tool to form the compression-formed body with the heating element and the shape.

The present invention relates to a vehicle interior component assembly comprising a subsystem element in a compression-formed body having a shape produced in a mold tool comprising a first surface and a second surface by a process comprising the steps of placing the subsystem element on a bottom layer; placing a top layer on the bottom layer with the subsystem element to provide a pre-form assembly; placing the pre-form assembly into the mold tool; and compressing the pre-form assembly between the first surface of the mold tool and a second surface of the mold tool to form the compression-formed body with the subsystem element and the shape. The subsystem element may comprise a component configured to be electrified. The subsystem element may be at least partially concealed within the compression-formed body.

The present invention relates to a component for a vehicle interior comprising a panel assembly; and a cover. The panel assembly may comprise a top layer, a heater and a structural layer.

### FIGURES

FIG. 1A is a schematic perspective view of a vehicle according to an exemplary embodiment.

FIG. 1B is a schematic perspective view of a vehicle showing a vehicle interior according to an exemplary embodiment.

FIGS. 2A and 2B are schematic perspective views of a vehicle door panel according to an exemplary embodiment.

FIG. 2C is a schematic perspective view of a vehicle door panel according to an exemplary embodiment.

FIG. 3A is a schematic perspective view of a vehicle door panel according to an exemplary embodiment.

FIG. 3B is a schematic exploded perspective view of a vehicle door panel according to an exemplary embodiment.

FIG. 3C is a schematic exploded perspective view of a vehicle interior component according to an exemplary embodiment.

FIGS. 4A to 4D are schematic perspective views of a process to form a panel assembly for a vehicle interior according to an exemplary embodiment.

FIGS. 5A to 5C are schematic perspective views of a process to form a vehicle interior component from the panel assembly according to an exemplary embodiment.

FIG. 5D is a schematic perspective detail view of the back side of the vehicle interior component according to an exemplary embodiment.

FIG. 5E is a schematic perspective view of the cover and panel for the vehicle interior component according to an exemplary embodiment.

FIG. 5F is a schematic perspective view of the vehicle interior component according to an exemplary embodiment.

FIG. 6 is a schematic flow diagram of a method for forming a vehicle interior component according to an exemplary embodiment.

FIG. 7A is a schematic flow diagram of a method for forming a vehicle interior component according to an exemplary embodiment.

FIG. 7B is a schematic flow diagram of a method for forming a vehicle interior component according to an exemplary embodiment.

FIG. 8A is a schematic flow diagram of a method for forming a vehicle interior component according to an exemplary embodiment.

FIG. 8B is a schematic flow diagram of a method for forming a vehicle interior component according to an exemplary embodiment.

FIG. 9A is a schematic flow diagram of a method for forming a vehicle interior component according to an exemplary embodiment.

FIG. 9B is a schematic flow diagram of a method for forming a vehicle interior component according to an exemplary embodiment.

FIG. 10A is a schematic flow diagram of a method for forming a vehicle interior component according to an exemplary embodiment.

FIG. 10B is a schematic flow diagram of a method for forming a vehicle interior component according to an exemplary embodiment.

FIG. 11A is a schematic flow diagram of a method for forming a vehicle interior component according to an exemplary embodiment.

FIG. 11B is a schematic flow diagram of a method for forming a vehicle interior component according to an exemplary embodiment.

FIGS. 12A to 12F are schematic section views of a process to form a vehicle interior component according to an exemplary embodiment.

FIGS. 12G to 12H are schematic perspective views of a process to form a vehicle interior component according to an exemplary embodiment.

FIG. 13 is a schematic flow diagram of a method for forming a vehicle interior component according to an exemplary embodiment.

FIG. 14A is a schematic flow diagram of a method for forming a vehicle interior component according to an exemplary embodiment.

FIG. 14B is a schematic flow diagram of a method for forming a vehicle interior component according to an exemplary embodiment.

FIG. 15A is a schematic flow diagram of a method for forming a vehicle interior component according to an exemplary embodiment.

FIG. 15B is a schematic flow diagram of a method for forming a vehicle interior component according to an exemplary embodiment.

FIG. 15C is a schematic flow diagram of a method for forming a vehicle interior component according to an exemplary embodiment.

### DESCRIPTION

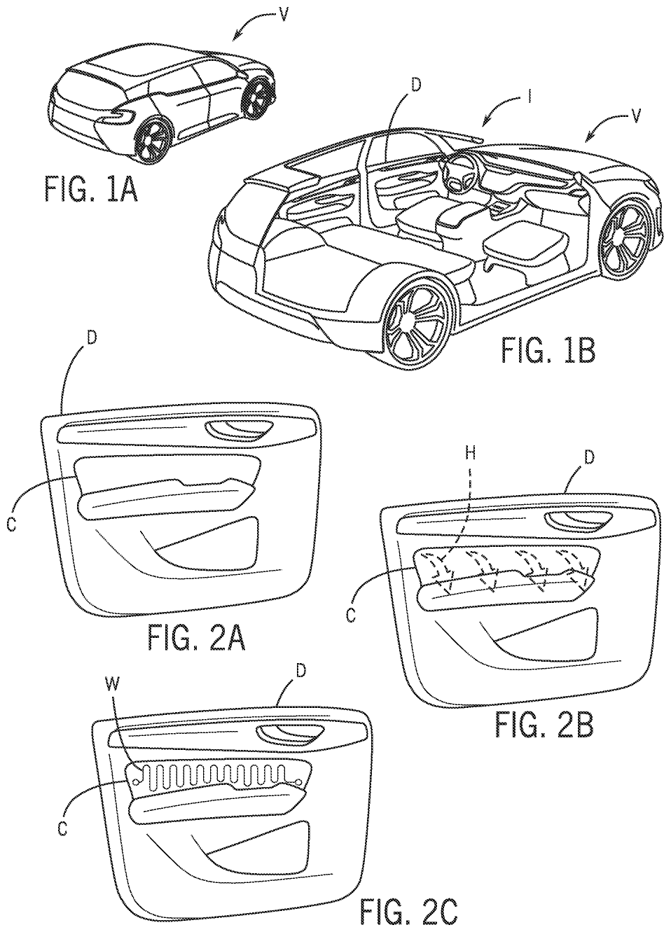

Referring to FIGS. 1A and 1B, a vehicle V providing an interior I is shown according to an exemplary embodiment. Interior I of vehicle V may comprise interior components/systems including panels (e.g. instrument panel, door panels, etc.) and consoles (e.g. floor console, overhead console, etc.) and other trim components shown as component C. Interior I of vehicle V may comprise a door/door panel D. See FIGS. 1B and 2A. Door/door panel D may provide heat H for the interior I. See FIG. 2B. Door/door panel D may comprise a heater/heating element/heat wire W configured to provide heat for the interior I. See FIG. 2C.

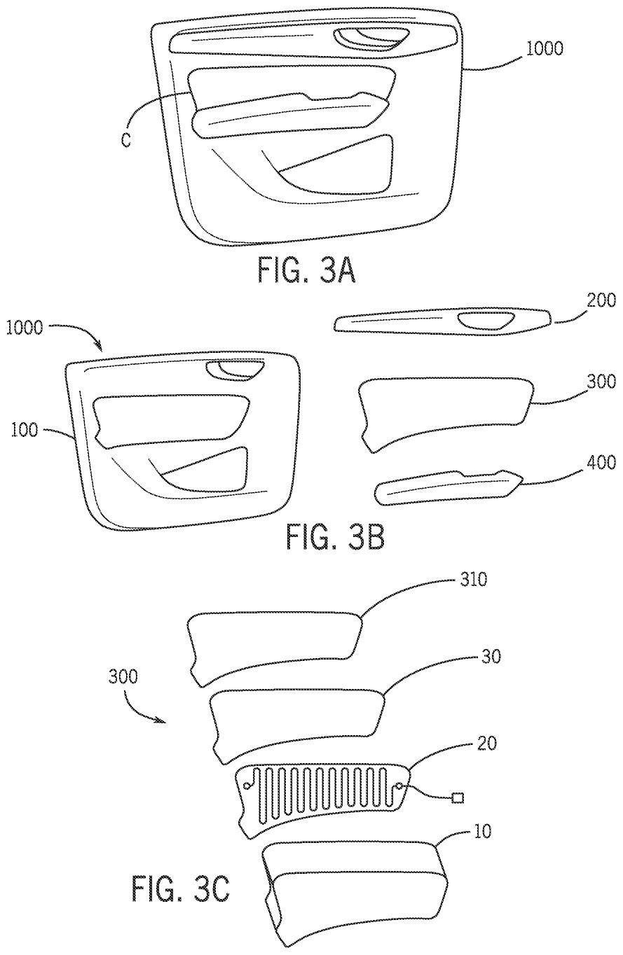

According to an exemplary embodiment as shown schematically in FIGS. 3A-3B, a door panel 1000 may comprise at least one of (a) a carrier 100; (b) a trim component 200; (c) a vehicle interior component assembly C/300; (d) an armrest 400. According to an exemplary embodiment as shown schematically in FIG. 3C, a vehicle interior component assembly 300 may comprise a structural layer/member/backing/natural fiber/polypropylene mat 10, a heater/electric heating element/electric resistance heating element 20 and a cover 310.

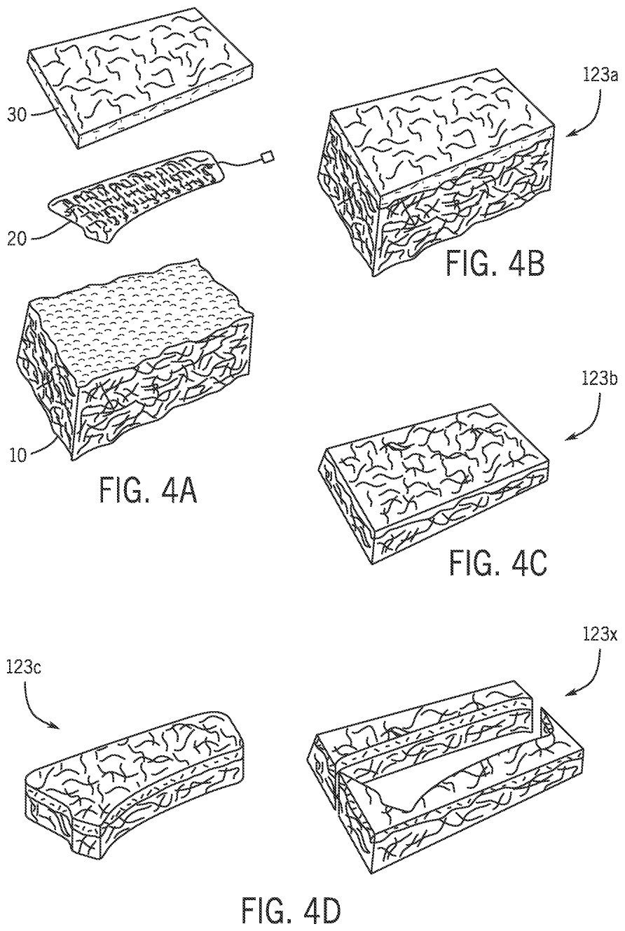

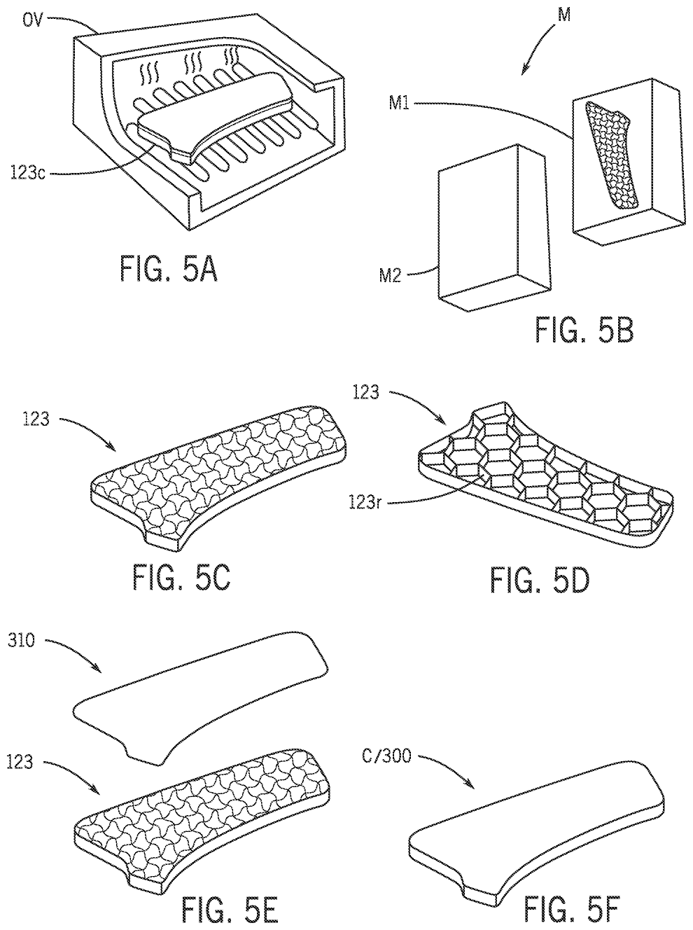

According to an exemplary embodiment as shown schematically in FIGS. 4A-4D and 5A-5F, a vehicle interior component 300 may be prepared by a process comprising forming a natural fiber/polypropylene mat 10 (e.g. needling natural fibers and polypropylene fibers to form the mat), trimming the natural fiber/polypropylene mat to a size, applying an adhesive to the natural fiber/polypropylene mat, applying a heater 20 to the natural fiber/polypropylene mat, applying an adhesive to the heater and applying a fabric 30 to the adhesive on the heater. The process may comprise applying an adhesive to the fabric. The process may comprise consolidating the layers together in a tool (see FIG. 4B) to form a consolidated assembly 123a, placing the consolidated assembly in a forming press/injection molding device and forming a compressed consolidated assembly 123b, and trimming the compressed consolidated assembly to form a pre-form assembly/panel/panel assembly 123c (with excess material/offal 123x). See FIG. 4D. The process may comprise heating the pre-form assembly (e.g. in an oven OV). See FIG. 5A. The process may comprise placing the pre-form assembly in a mold/mold tool M and forming the pre-form assembly into a compression formed body 123. See FIGS. 5B-5D. The process may comprise injection molding features/ancillary components 123r (e.g. ribs, retainer, etc.) on the compression formed body. See FIG. 5D. The process may comprise joining a cover 310 to the compression formed body. See FIG. 5E.

According to an exemplary embodiment as shown schematically in FIGS. 2A-2C, 3A-3C, 4A-4D and 5A-5F, a vehicle interior component 300 may comprise a heating element 20 in a compression-formed body 123 having a shape produced in a mold tool M comprising a first surface M1 and a second surface M2 by a process comprising the steps of placing the heating element on a fiber layer/structural layer 10; placing the fiber layer into the mold tool; and compressing the fiber layer with the heating element between the first surface of the mold tool and the second surface of the mold tool to form the compression-formed body with the heating element and the shape. The process may further comprise the step of providing a pre-form assembly 123c comprising the fiber layer as a base for the heating element and a fabric layer/fabric sheet/top layer 30 over the heating element. The pre-form assembly may comprise a panel assembly. The process may further comprise the step of trimming the panel assembly. See FIG. 4D. The process may further comprise the step of heating the pre-form assembly. See FIG. 5A. The step of compressing the fiber layer may comprise compressing the pre-form assembly into the compression-formed body with the shape. The fiber layer may comprise at least one of (a) a panel; (b) a mat; (c) a batt; (d) a fiber panel; (e) a fiber mat; (f) a fiber batt. The mold tool may comprise a textured surface; the compression-formed body may be formed with a textured surface. The heating element may be encapsulated in the compression-formed body. The heating element may comprise an electric heating element. The process may further comprise the step of placing a fabric sheet on the heating element so that the heating element is between the fiber layer and the fabric sheet. See FIGS. 4A and 4B. The compression-formed body may comprise a formed panel assembly. The panel assembly may comprise the heating element and a structural layer; an inner surface of the heater may be coupled to an outer surface of the structural layer. The panel assembly may further comprise a top layer coupled to an outer surface of the heating element. The top layer may comprise an outer surface with a smooth texture; the outer surface of the structural layer may comprise a rough texture. The top layer may be configured to provide improved profile tolerance for the vehicle interior component. The structural layer may comprise natural fibers and a resin; the top layer may comprise polypropylene and polyester. The resin may comprise polypropylene; the natural fibers may comprise at least one of (a) flax; (b) kenaf. The top layer may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The top layer may comprise an area weight of between 200 grams per square meter and 300 grams per square meter. The process may comprise the steps of activating the top layer of the panel assembly and adhering a cover 310 to the top layer of the panel assembly. The process may further comprise the step of consolidating a top layer and the heating element and a structural layer to form the panel assembly before formation of the compression-formed body. The structural layer may comprise the fiber layer; the top layer may comprise a fabric panel. The process may comprise the step of consolidating the heating element and a structural layer to form a panel assembly. The panel assembly may comprise an area weight of between 1000 grams per square meter and 1800 grams per square meter. The panel assembly may comprise a thickness of between 1.5 millimeters and 4 millimeters. The process may comprise the step of heating the panel assembly; the panel assembly may be compressed as the panel assembly cools. The process may comprise the step of injecting resin into the mold tool after a compression formed component is formed to form an ancillary component of the vehicle interior component assembly. The process may comprise the step of disposing a cover onto the compression formed body to form the vehicle interior component assembly.

According to an exemplary embodiment as shown schematically in FIGS. 2A-2C, 3A-3C, 4A-4D and 5A-5F, a vehicle interior component assembly may comprise a subsystem element in a compression-formed body having a shape produced in a mold tool comprising a first surface and a second surface by a process comprising the steps of placing the subsystem element on a bottom layer; placing a top layer on the bottom layer with the subsystem element to provide a pre-form assembly; placing the pre-form assembly into the mold tool; and compressing the pre-form assembly between the first surface of the mold tool and a second surface of the mold tool to form the compression-formed body with the subsystem element and the shape. The subsystem element may comprise a component configured to be electrified. The subsystem element may be at least partially concealed within the compression-formed body. The compression-formed body may comprise a structural element. The compression-formed body may comprise the subsystem element and the structural element. The compression-formed body may comprise the subsystem element concealed between the top layer and the bottom layer. The top layer may comprise a panel and the bottom layer may comprise a structural element. The structural element may comprise a panel; the panel may comprise a fiber batt. The bottom layer may comprise a fiber mat and the top layer may comprise a fabric panel. The bottom layer may comprise a fiber mat. The subsystem element may comprise a heating element. The heating element may comprise an electric heating element. The electric heating element may comprise an electric resistance heating element. The component assembly may further comprise a cover for the compression-formed body. The cover may comprise a surface texture. The cover may comprise at least one of (a) a film; (b) a fabric; (c) a sheet; (d) a coating; (e) paint. The process may further comprise the step of providing the bottom layer as a fiber layer. The process may further comprise the step of applying an adhesive for the subsystem element. The process may further comprise the step of applying a fabric layer. The process may further comprise the step of applying a cover to the compression-formed body. The compression-formed body may be formed as a panel.

According to an exemplary embodiment as shown schematically in FIGS. 2A-2C, 3A-3C, 4A-4D and 5A-5F, a component for a vehicle interior may comprise a panel assembly; and a cover. The panel assembly may comprise a top layer, a heater and a structural layer. The top layer may comprise an outer surface with a smooth texture and the structural layer may comprise an outer surface with a rough texture. The top layer may be configured to provide improved profile tolerance for the component. The structural layer may comprise natural fibers and a resin; the top layer may comprise polypropylene and polyester. The resin may comprise polypropylene; the natural fibers may comprise at least one of (a) flax; (b) kenaf. The cover may comprise at least one of (a) leather; (b) artificial leather. The cover may comprise at least one of (a) woven fabric; (b) non-woven fabric; (c) an applique; (d) vinyl; (e) foil. The heater may comprise a substrate and a wire coupled to the substrate of the heater. The substrate of the heater may comprise polypropylene fibers. The polypropylene fibers may be bonded to at least one of (a) the top layer; (b) the structural layer.

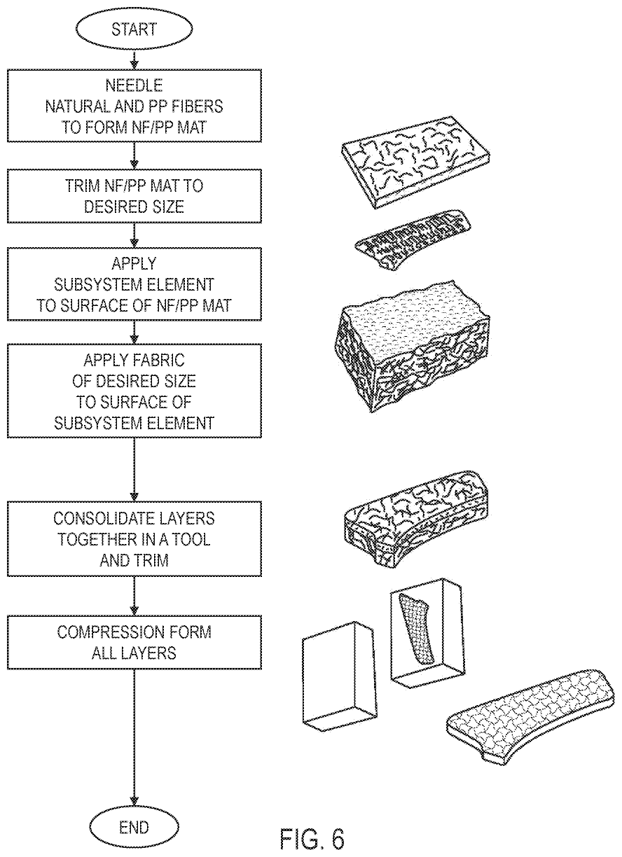

According to an exemplary embodiment as shown schematically in FIG. 6, a vehicle interior component may be prepared by a process comprising needling natural and polypropylene fibers to form a natural fiber/polypropylene mat, trimming the natural fiber/polypropylene mat to a desired size, applying a subsystem element to a surface of the natural fiber/polypropylene mat, applying a fabric of a desired size to a surface of the subsystem element, consolidating the layers together in a tool, trimming the consolidated layers and compression forming the layers.

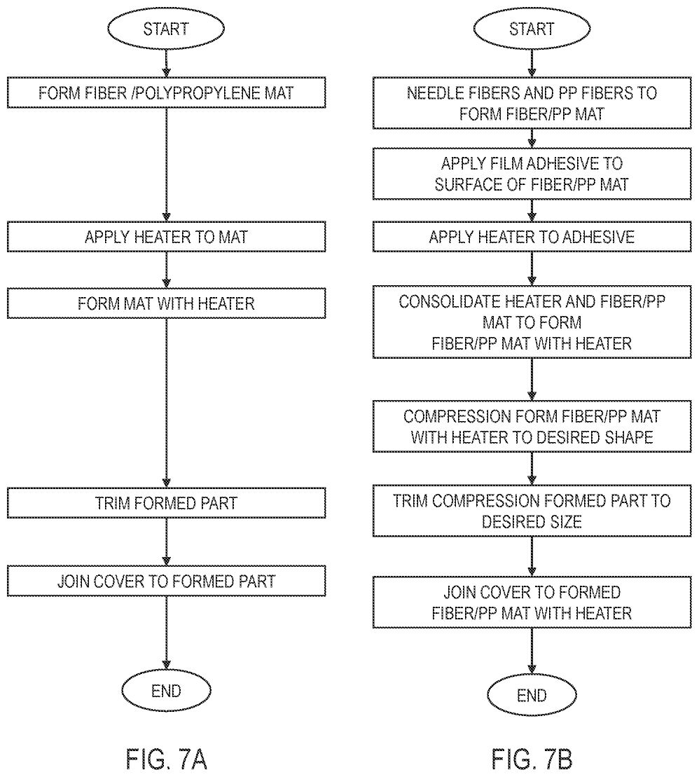

According to an exemplary embodiment as shown schematically in FIG. 7A, a vehicle interior component may be prepared by a process comprising forming a fiber/polypropylene mat, applying a heater to the mat, forming the mat with the heater, trimming the formed part and joining a cover to the formed part.

According to an exemplary embodiment as shown schematically in FIG. 7B, a vehicle interior component may be prepared by a process comprising needling fibers and polypropylene fibers to form a fiber/polypropylene mat, applying a film adhesive to a surface of the fiber/polypropylene mat, applying a heater to the film adhesive, consolidating the heater and the fiber/polypropylene mat to form a fiber/polypropylene mat with the heater, compression forming the fiber/polypropylene mat with the heater to a desired shape, trimming the compression formed part to a desired size and joining a cover to the formed fiber/polypropylene mat with the heater.

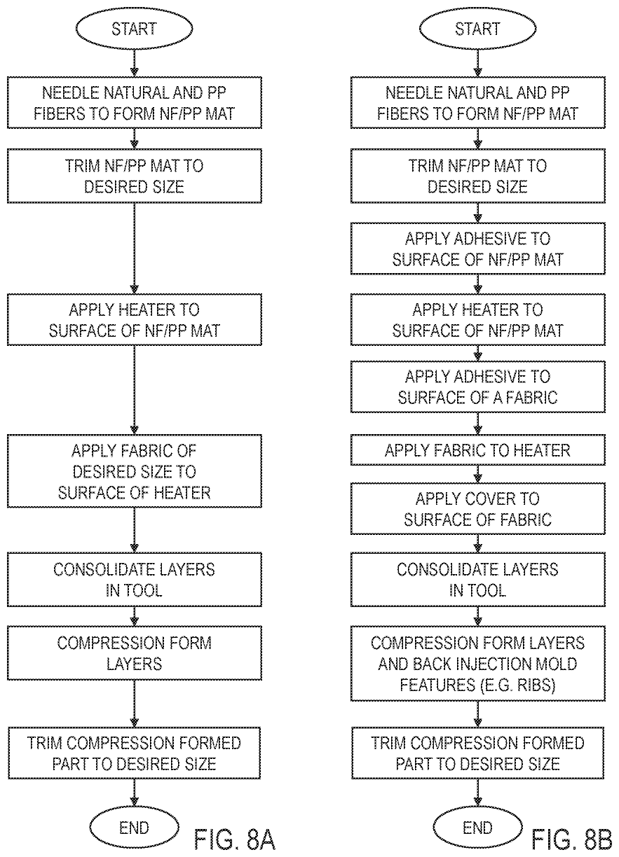

According to an exemplary embodiment as shown schematically in FIG. 8A, a vehicle interior component may be prepared by a process comprising needling natural and polypropylene fibers to form a natural fiber/polypropylene mat, trimming the natural fiber/polypropylene mat to a desired size, applying a heater to a surface of the natural fiber/polypropylene mat, applying a fabric of a desired size to a surface of the heater, consolidating the layers together in a tool, compression forming the layers and trimming the compression formed part to a desired size.

According to an exemplary embodiment as shown schematically in FIG. 8B, a vehicle interior component may be prepared by a process comprising needling natural and polypropylene fibers to form natural a fiber/polypropylene mat, trimming the natural fiber/polypropylene mat to a desired size, applying an adhesive to a surface of the natural fiber/polypropylene mat, applying a heater to a surface of the natural fiber/polypropylene mat, applying an adhesive to a surface of a fabric, applying the fabric to the heater, applying a cover to a surface of the fabric, consolidating the layers together in a tool, compression forming the layers, back injection molding features (e.g. ribs, etc.) on the compression formed part and trimming the compression formed part to a desired size.

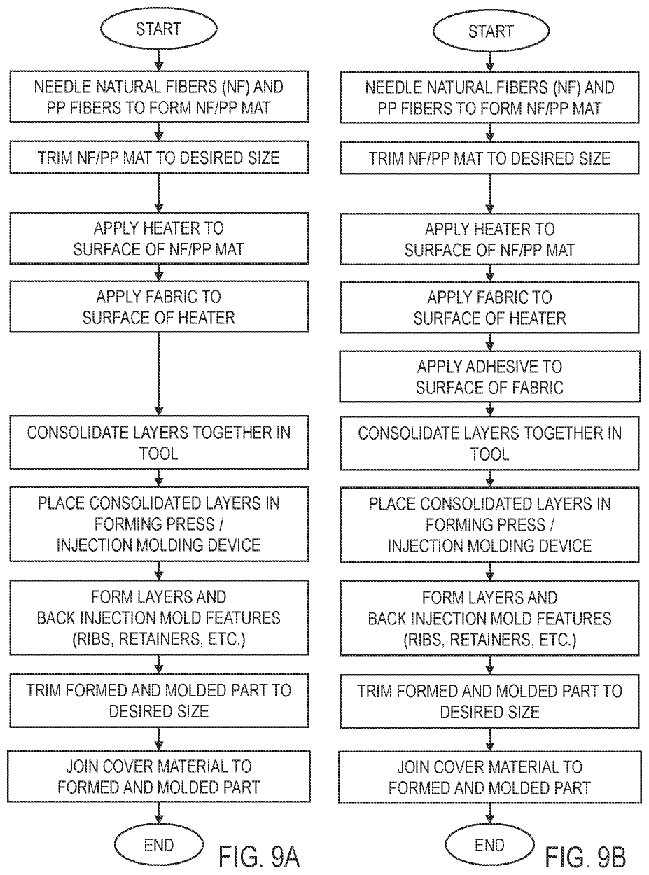

According to an exemplary embodiment as shown schematically in FIG. 9A, a vehicle interior component may be prepared by a process comprising needling natural fibers and polypropylene fibers to form a natural fiber/polypropylene mat, trimming the natural fiber/polypropylene mat to a desired size, applying a heater to a surface of the natural fiber/polypropylene mat, applying a fabric to a surface of the heater, consolidating the layers together in a tool, placing the consolidated layers in a forming press/injection molding device, forming the layers and back injection molding features (e.g. ribs, retainers, etc.) on the formed layers, trimming the formed and molded part to a desired size and joining a cover material to the formed and molded part.

According to an exemplary embodiment as shown schematically in FIG. 9B, a vehicle interior component may be prepared by a process comprising needling natural fibers and polypropylene fibers to form a natural fiber/polypropylene mat, trimming the natural fiber/polypropylene mat to a desired size, applying a heater to a surface of the natural fiber/polypropylene mat, applying a fabric to a surface of the heater, applying an adhesive to a surface of the fabric, consolidating the layers together in a tool, placing the consolidated layers in a forming press/injection molding device, forming the layers and back injection molding features (e.g. ribs, retainers, etc.) on the layers, trimming the formed and molded part to a desired size and joining a cover material to the formed and molded part.

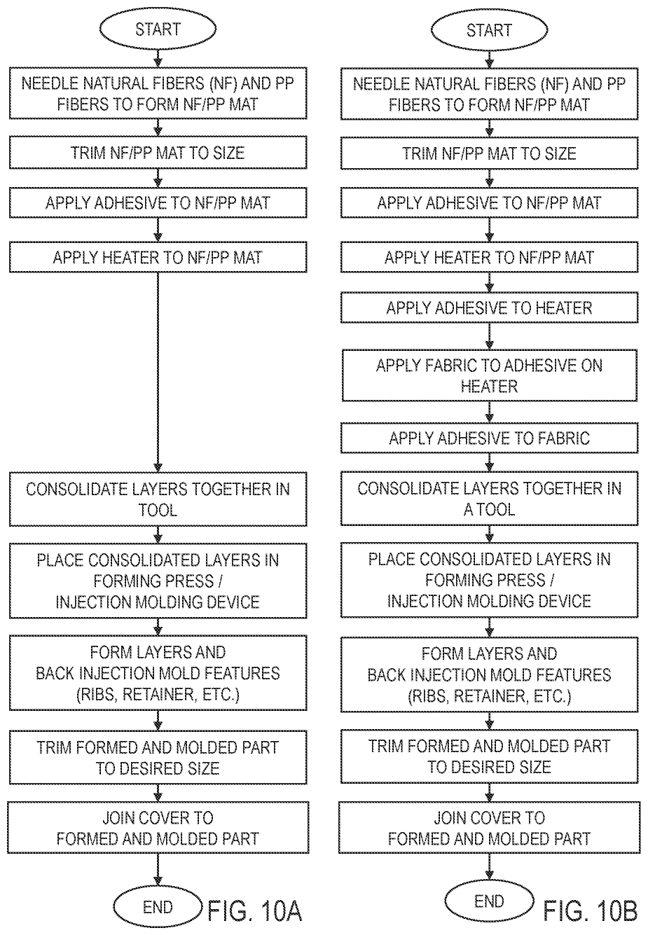

According to an exemplary embodiment as shown schematically in FIG. 10A, a vehicle interior component may be prepared by a process comprising needling natural fibers and polypropylene fibers to form a natural fiber/polypropylene mat, trimming the natural fiber/polypropylene mat to a size, applying an adhesive to the natural fiber/polypropylene mat, applying a heater to the natural fiber/polypropylene mat, consolidating the layers together in a tool, placing the consolidated layers in a forming press/injection molding device, forming the consolidated layers and back injection molding features (e.g. ribs, retainer, etc.) on the formed layers, trimming the formed and molded part to a desired size and joining a cover to the formed and molded part.

According to an exemplary embodiment as shown schematically in FIG. 10B, a vehicle interior component may be prepared by a process comprising needling natural fibers and polypropylene fibers to form a natural fiber/polypropylene mat, trimming the natural fiber/polypropylene mat to a size, applying an adhesive to the natural fiber/polypropylene mat, applying a heater to the natural fiber/polypropylene mat, applying an adhesive to the heater, applying a fabric to the adhesive on the heater, applying an adhesive to a fabric, consolidating the layers together in a tool, placing the consolidated layers in a forming press/injection molding device, forming the layers and back injection molding features (e.g. ribs, retainer, etc.) on the layers, trimming the formed and molded part to a desired size and joining a cover to the formed and molded part.

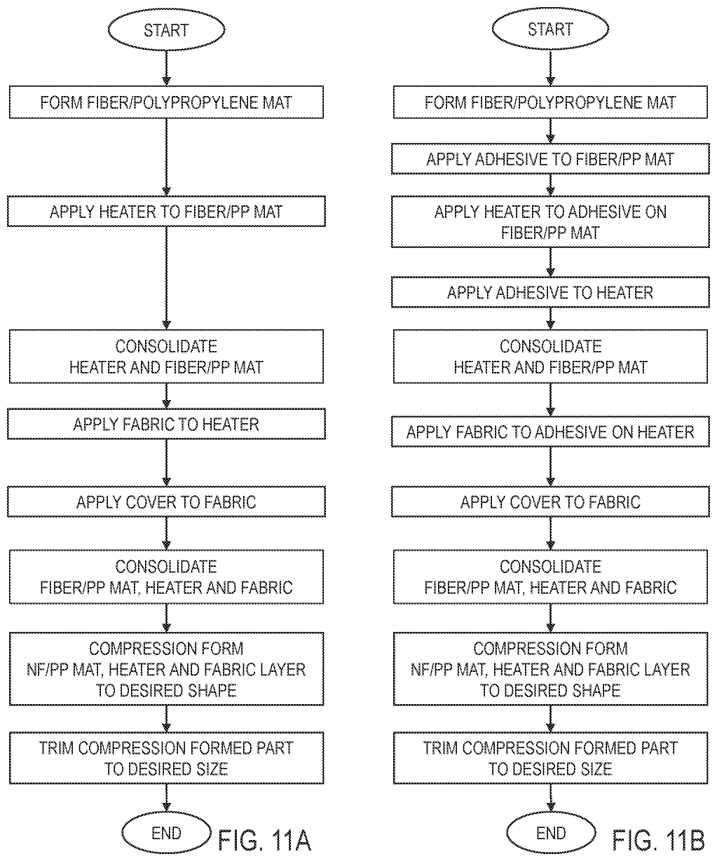

According to an exemplary embodiment as shown schematically in FIG. 11A, a vehicle interior component may be prepared by a process comprising forming a fiber/polypropylene mat, applying a heater to the fiber/polypropylene mat, consolidating the heater and the fiber/polypropylene mat, applying a fabric to the heater, applying a cover to the fabric, consolidating the fiber/polypropylene mat, the heater and the fabric, compression forming the natural fiber/polypropylene mat, heater and fabric layer to a desired shape and trimming the compression formed part to a desired size.

According to an exemplary embodiment as shown schematically in FIG. 11B, a vehicle interior component may be prepared by a process comprising forming a fiber/polypropylene mat, applying an adhesive to the fiber/polypropylene mat, applying a heater to the adhesive on the fiber/polypropylene mat, applying an adhesive to the heater, consolidating the heater and the fiber/polypropylene mat, applying a fabric to the adhesive on the heater, applying a cover to the fabric, consolidating the fiber/polypropylene mat, the heater and the fabric, compression forming the natural fiber/polypropylene mat, heater and fabric layer to a desired shape and trimming the compression formed part to a desired size.

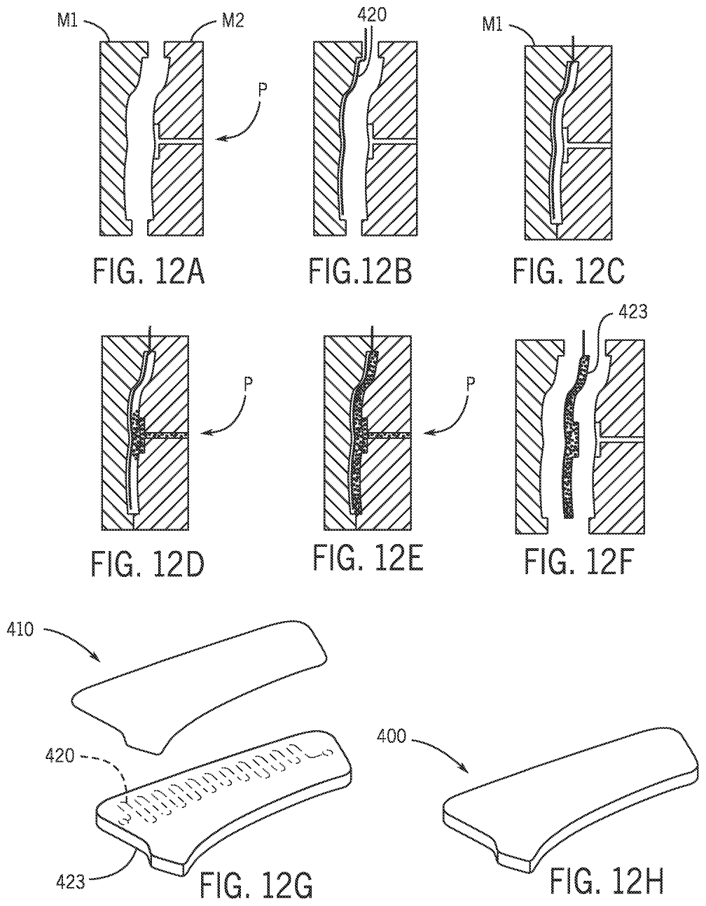

According to an exemplary embodiment as shown schematically in FIGS. 2A-2C and 12A-12H, a vehicle interior component assembly 400 may comprise a subsystem element 420 in a formed body 423 having a shape produced in a mold tool M1/M2 by a process comprising the steps of placing a subsystem element 420 into the mold tool; and molding the formed body (e.g. by injecting resin through a port P) in the mold tool with the subsystem element and the shape. The subsystem element may comprise a component configured to be electrified. The subsystem element may be at least partially concealed within the formed body. The formed body may comprise a molded body. The subsystem element may be molded into the molded body. The component assembly may further comprise a cover 410. The cover may comprise a surface texture. The component assembly may further comprise a structural member. The process further may comprise the step of applying an adhesive for the subsystem element. The process further may comprise the step of applying a paint. The process further may comprise the step of applying a cover. The formed body may be formed as a plastic material. The formed body may be formed from resin. The mold tool may comprise a textured surface; the formed body may be formed from resin with a textured surface. The subsystem element may comprise a heating element; the formed body may be formed from resin to encapsulate the heating element. The heating element may comprise an electric heating element providing at least one wire configured to be exposed from the formed body for connection to the electric heating element. The subsystem element may comprise a heater.

According to an exemplary embodiment as shown schematically in FIGS. 2A-2C and 12A-12H, a vehicle interior component may be prepared by a process comprising disposing a heater onto a first surface of a mold; and injecting a resin into the mold between the heater and a second surface of the mold to form a panel assembly having a shape wherein the shape corresponds to a first contour of the first surface and a second contour of the second surface. The first surface of the mold may comprise a texture configured to form a textured surface of the heater. The process may comprise the step of disposing a cover onto the panel assembly to form the vehicle interior component. The heater may comprise at least one wire; the textured surface of the heater may be configured to provide a generally planar surface to the cover.

According to an exemplary embodiment as shown schematically in FIGS. 2A-2C and 12A-12H, a component for a vehicle interior may comprise a panel assembly; and a cover coupled to the panel assembly. The panel assembly may comprise a heater coupled to a generally rigid structural layer. The heater may comprise at least one connector. The cover may comprise a textured surface configured to provide a generally planar outer surface for the component. The panel assembly may be formed by molding a resin on the heater in a tool. The tool may comprise a surface configured to form a textured surface on the heater. The cover may be coupled to the heater. The cover may comprise at least one of (a) paint; (b) leather; (c) artificial leather; (d) vinyl; (e) woven fabric, (f) non-woven fabric, (g) an applique, (h) foil. The connector may comprise a wire. See e.g. FIG. 3C.

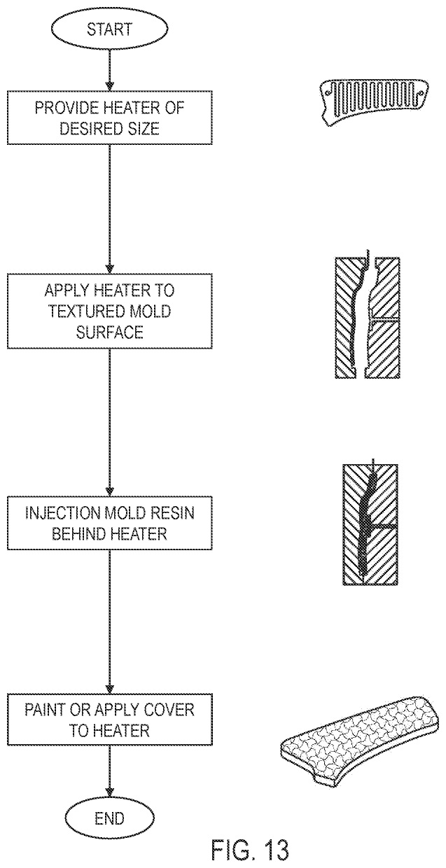

According to an exemplary embodiment as shown schematically in FIG. 13, a vehicle interior component may be prepared by a process comprising providing a heater of a desired size, applying a heater to a textured mold surface, injection molding resin behind the heater and painting or applying a cover to the heater.

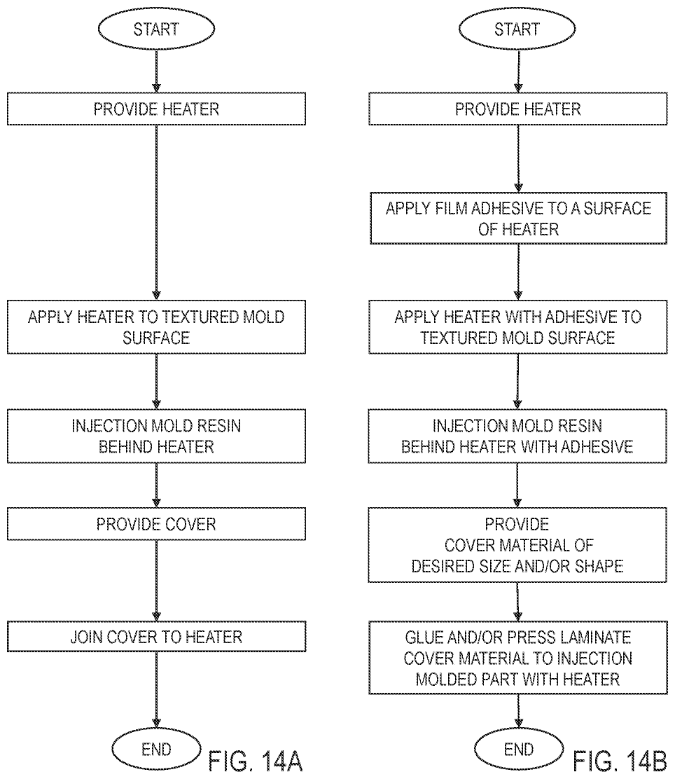

According to an exemplary embodiment as shown schematically in FIG. 14A, a vehicle interior component may be prepared by a process comprising providing a heater, applying the heater to a textured mold surface, injection molding a resin behind the heater, providing a cover and joining the cover to the heater.

According to an exemplary embodiment as shown schematically in FIG. 14B, a vehicle interior component may be prepared by a process comprising providing a heater, applying a film adhesive to a surface of the heater, applying the heater with the film adhesive to a textured mold surface, injection molding resin behind the heater with the adhesive, providing a cover material of a desired size and/or shape and gluing and/or press laminating the cover material to the injection molded part with the heater.

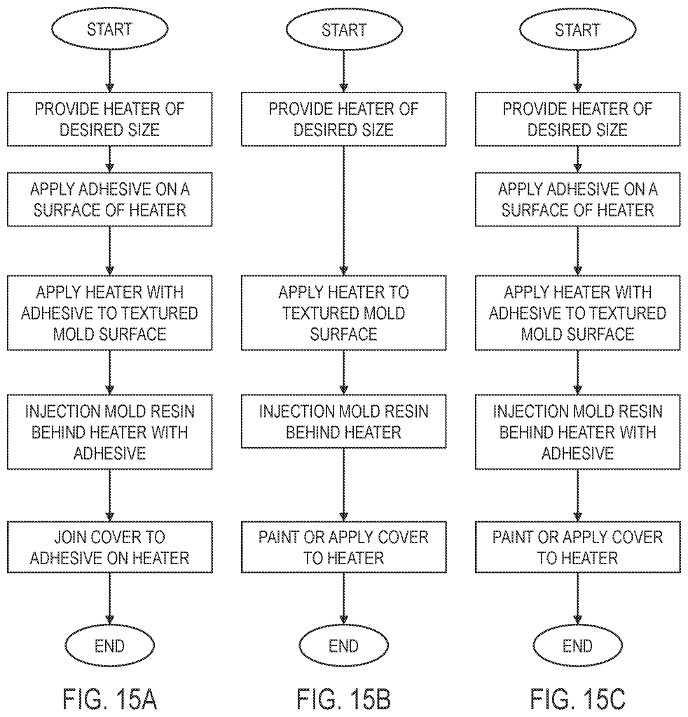

According to an exemplary embodiment as shown schematically in FIG. 15A, a vehicle interior component may be prepared by a process comprising providing a heater of a desired size, applying an adhesive on a surface of the heater, applying the heater with the adhesive to a textured mold surface, injection molding resin behind the heater with the adhesive and joining a cover to the adhesive on the heater.

According to an exemplary embodiment as shown schematically in FIG. 15B, a vehicle interior component may be prepared by a process comprising providing a heater of a desired size, applying the heater to a textured mold surface, injection molding resin behind the heater and painting or applying a cover to the heater.

According to an exemplary embodiment as shown schematically in FIG. 15C, a vehicle interior component may be prepared by a process comprising providing a heater of desired size, applying an adhesive on a surface of the heater, applying the heater with the adhesive to a textured mold surface, injection molding resin behind the heater with the adhesive and painting or applying a cover to the heater.

According to an exemplary embodiment the process for forming/producing the component may comprise a combination (e.g. set/subset) of the steps as indicated schematically/representationally in FIGS. 6, 7A, 7B, 8A, 8B, 9A, 9B, 10A, 10B, 11A, 11B, 13, 14A, 14B and 15A-15C.

### Exemplary Embodiments—A

According to an exemplary embodiment shown schematically in FIGS. 6, 7A-7B, 8A-8B, 9A-9B, 10A-10B and 11A-11B, a vehicle interior component assembly C comprising a heating element 20 may be produced in a mold tool M by a process comprising the steps of assembling the heating element 20 with a fiber layer 10 to provide a pre-form assembly 123a; consolidating the pre-form assembly into a consolidated/shaped pre-form assembly 123b; placing the pre-form assembly into the mold tool; forming the pre-form assembly into a compression-formed body 123 with a shape; applying a cover 310 to the compression-formed body to provide a compression-formed panel C/300; so that the compression-formed panel C/300 is provided with the shape and an external surface. See also FIGS. 3A-3B, 4A-4D and 5A-5F. According to an exemplary embodiment shown schematically in FIGS. 3C and 4A, the heating element may comprise a heating panel.

As shown schematically, the fiber layer may comprise a structural layer for the pre-form assembly; the fiber layer may comprise at least one of (a) a panel; (b) a mat; (c) a batt; (d) a fiber panel; (e) a fiber mat; (f) a fiber batt; (g) a natural fiber material; (h) a polypropylene material; (i) a natural fiber and polypropylene mat; (j) a mat formed from natural fibers and polypropylene fibers.

According to an exemplary embodiment as indicated schematically in FIGS. 5A-5F, the step of forming the pre-form assembly into the compression-formed body may comprise compressing the pre-form assembly in the mold tool. The step of forming the pre-form assembly into a compression-formed body may comprise compressing the fiber layer with the heating element in the mold tool to form the compression-formed panel with the shape. The external surface of the compression-formed panel may comprise a texture provided by cover. The mold tool may comprise a mold cavity with a surface. The external surface of the compression-formed panel may comprise a texture at least partially formed by the surface of the mold tool. The external surface of the compression-formed panel may comprise a texture provided by cover and at least partially by the surface of the mold tool. The mold tool may comprise a mold cavity with a shape. The shape of the compression-formed panel may be at least partially provided by the shape of the mold tool.

According to an exemplary embodiment shown schematically in FIGS. 5E-5F, the process may further comprise the step of providing a cover 310 for the compression-formed body 123 so that the external surface of the compression-formed panel C/300 may be provided by the cover. According to an exemplary embodiment shown schematically in FIGS. 5A-5F, the mold tool M may comprise a textured surface; the step of forming the pre-form assembly into the compression-formed body may comprise compressing the fiber layer with the heating element and at least partially forming the textured surface on the compression-formed body. The textured surface may be at least partially formed on external surface of the compression-formed panel.

According to an exemplary embodiment shown schematically in FIGS. 4A-4D, the process may further comprise the step of applying a cover layer 30 for the pre-form assembly 123a (with heating element 20 and fiber layer 10). The cover layer for the pre-form assembly may comprise at least one of a fiber layer or a fabric layer. The cover layer for the pre-form assembly may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The fiber layer 10 of the pre-form assembly 123a may comprise a structural layer; the structural layer may comprise natural fibers and a resin; the cover layer 30 may comprise polypropylene and polyester.

According to an exemplary embodiment shown schematically in FIGS. 4A-4D, the step of assembling the heating element with the fiber panel may comprise assembling the heating element with the fiber panel with a cover layer to provide the pre-form assembly; and the step of consolidating the pre-form assembly may comprise consolidating the fiber panel with the heating element and the cover layer. The step of compressing the fiber layer with the heating element in the mold tool to form the compression-formed body may comprise compressing the fiber layer with the heating element and the cover layer to form the compression-formed body. The mold tool may comprise a textured surface; and compressing the fiber layer with the heating element with the cover in the mold tool may comprise at least partially forming the textured surface on the cover of the compression-formed body.

According to an exemplary embodiment shown schematically in FIGS. 4A-4D, the step of consolidating the pre-form assembly 123a may comprise shaping a consolidated pre-form assembly 123b/123c. The step of consolidating the pre-form assembly may comprise heating the pre-form assembly. The process may further comprise the step of trimming the pre-form assembly 123c. See FIG. 4D. The process may further comprise the step of shaping the pre-form assembly 123b/123c. See FIGS. 4C-4D. The step of shaping the pre-form assembly may comprise trimming the pre-form assembly 123c (with removal of excess material 123x). The pre-form assembly 123c may be heated, see FIG. 5A.

According to an exemplary embodiment shown schematically in FIGS. 5A-5F, the step of forming the pre-form assembly into the compression-formed body may comprise compression of the pre-form assembly 123c into the shape. The step of forming the pre-form assembly into the compression-formed body 123 may comprise application of heat to form the compression-formed body into the shape. As indicated schematically, the shape may comprise a contoured shape; the shape may comprise a formed shape. According to an exemplary embodiment indicated schematically in FIGS. 2A, 3A and 5E-5F, the cover may comprise a surface texture (e.g. suitable for a vehicle interior component). The cover may comprise at least one of (a) a film; (b) a fabric; (c) a sheet; (d) a coating; (e) paint.

According to an exemplary embodiment, the vehicle interior component provided by the compression-formed panel with cover will provide an external surface with a texture/feel that obscures the feel of the heating panel within the compression-formed panel. See e.g. FIGS. 2A and 3A.

According to an exemplary embodiment shown schematically in FIGS. 6, 7A-7B, 8A-8B, 9A-9B, 10A-10B and 11A-11B, a vehicle interior component assembly C/300 comprising a heating element 20 may be produced in a mold tool M by a process comprising the steps of assembling the heating element 20 between a cover layer 30 and a fiber layer 10 to provide a pre-form assembly 123a; consolidating the pre-form assembly 123b/123c; placing the pre-form assembly into the mold tool; forming the pre-form assembly 123c into a compression-formed body 123 with a shape; applying a cover 310 to the compression-formed body 123 to provide a compression-formed panel C/300; the compression-formed panel C/300 may be provided with the shape and an external surface provided by the cover. See also FIGS. 4A-4D and 5A-5F.

As indicated schematically in FIGS. 5A-5B, the mold tool M may comprise a surface; the external surface of the compression-formed panel may be at least partially provided by the surface of the mold tool.

According to an exemplary embodiment shown schematically in FIGS. 4A-4D, the step of consolidating the pre-form assembly may comprise at least partially compressing the cover layer 30 and heating element 20 and fiber layer 10. The step of consolidating the pre-form assembly may comprise shaping/trimming the pre-form assembly. See FIGS. 4C and 4D. The step of assembling the pre-form assembly may comprise the application of adhesive; the step of consolidating the pre-form assembly may comprise securing the heating element between the cover layer and the fiber layer with adhesive. According to an exemplary embodiment shown schematically in FIGS. 4A-4D and 5A, the fiber layer 10 may comprise a structural layer for the pre-form. The cover layer may be configured for application of the cover; so that the cover may be secured to the cover layer to provide the compression-formed panel with the external surface. See FIGS. 5E and 5F. The external surface of the cover of the compression-formed panel may be configured to provide a texture provided by the cover and the cover layer. The fiber layer of the pre-form assembly may comprise a structural layer; the structural layer may comprise natural fibers and a resin; the cover layer may comprise polypropylene and polyester. The fiber layer may comprise at least one of (a) a panel; (b) a mat; (c) a batt; (d) a fiber panel; (e) a fiber mat; (f) a fiber batt; (g) a natural fiber material; (h) a polypropylene material; (i) a natural fiber and polypropylene mat; (j) a mat formed from natural fibers and polypropylene fibers. The cover layer for the pre-form assembly may comprise at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet. The cover may comprise at least one of (a) a film; (b) a fabric; (c) a sheet; (d) a coating; (e) paint.

The heating element may comprise a heating panel (e.g with connector), see FIGS. 3C and 4A.

As indicated schematically in FIGS. 4A-4D, the vehicle interior component assembly C/300 may be produced by assembling the heating element 20 between a cover layer 30 and a fiber layer 10 to provide a pre-form assembly 123a that is consolidated into a consolidated pre-form assembly 123b/123c (e.g. compressed and/or formed and/or shaped and/or trimmed, etc.); the consolidated pre-form assembly 123c may be heated and placed into a mold tool M to be formed/compressed into a compression-formed body 123 with a shape; the compression-formed panel C/300 may be produced by applying a cover 310 to the compression-formed body 123. See FIGS. 5A-5F. As indicated schematically according to an exemplary embodiment in FIGS. 2A-2B, 3A and 5F, the compression-formed panel C/300 with heating element 20 (with connector) may comprise the shape and an external surface provided by the cover. See also FIGS. 3C, 4A and 5A-5E.

According to an exemplary embodiment, the vehicle interior component with heating element (shown as heating panel 20) may comprise a fiber layer providing a structural layer (shown schematically/representationally as carrier/material 10) and a fiber layer providing a cover layer (shown schematically/representationally as top layer/material 30). As indicated schematically, the fiber layers for the structural layer and cover layer may comprise any of a wide variety of fibers/materials produced by any of a wide variety of techniques and treatments into any of a wide variety of forms/mats/panels. According to an exemplary embodiment, the fiber layers may be selected to provide an external surface for the component comprising reduced variation in texture/profile at the external surface notwithstanding the heating element contained within the component (e.g. such that the heating element is not substantially visible and/or substantially perceptible). The fiber layers may comprise a non-woven material comprising fibers of various forms (e.g. lengths, types, etc.); the fiber layers may be formed from a variety of processes (e.g. dry process such as by laying, blowing, carding, etc. or a wet process such as in a water-based process or etc.) and treated (e.g. strengthened mechanically, needled, treated thermally, calendared, treated chemically, treated with a binder, impregnated with material, sprayed, etc.) to provide the form of the fiber layer (e.g. panel, mat, batt, etc.). See e.g. FIGS. 4A and 6.

As indicated schematically according to an exemplary embodiment shown in FIGS. 4A and 6, the type of construction/material for the fiber layer for the structural layer (e.g. with natural fibers, with longer fibers, with resin, with greater thickness, with wider variation, etc.) may be different than the type of construction/material for the fiber layer for the cover layer (e.g. with natural fibers, with shorter fibers, with resin, with polypropylene, with polyester, etc.); the structural layer may comprise fibers of a length of approximately 10-15 cm (e.g. long fibers); the cover layer may comprise fibers of a shorter length (e.g. intended to present a decorative effect, texture, finer surface quality, etc.). As indicated schematically in FIGS. 2A-2B, 3A, 4A-4D, 5A-5F and 6, the cover layer may comprise a fiber layer/panel presenting an outer surface with a relatively smooth texture (e.g. with shorter fibers, from a wet process to provide finer surface quality, etc.); the structural layer may comprise a fiber layer/panel with a relatively rough texture (e.g. with longer fibers, mechanically strengthened such as by needling, subject to spinning effect, etc.). According to an exemplary embodiment, the cover layer may be configured to provide a relatively smooth texture over the heating element and improved profile tolerance for the external surface of the compression-formed panel comprising the vehicle interior component. See FIGS. 2A, 3A and 5F.

According to an exemplary embodiment as indicated schematically in FIGS. 4A-4D, 5A-5F and 6, the fiber layers may be produced by any suitable process configured to provide a suitable form for the fiber layers of the structural layer and cover layer for the compression-formed panel of the vehicle interior component. See also U.S. Patent Publication No. 2005/0215698 A1 (incorporated by reference) and U.S. Patent Publication No. 2007/0269645 A1 (incorporated by reference.)

### Exemplary Embodiments—B

As shown schematically according to an exemplary embodiment in FIGS. 12A-12H, a vehicle interior component assembly may comprise a subsystem element in a formed body having a shape produced in a mold tool by a process comprising the steps of placing a subsystem element into the mold tool; and molding the formed body in the mold tool with the subsystem element and the shape.

As shown schematically according to an exemplary embodiment in FIGS. 12A-12H, a vehicle interior component may be prepared by a process comprising disposing a heater onto a first surface of a mold; and injecting a resin into the mold between the heater and a second surface of the mold to form a panel assembly having a shape wherein the shape corresponds to a first contour of the first surface and a second contour of the second surface.

As shown schematically according to an exemplary embodiment in FIGS. 12A-12H, a component for a vehicle interior may comprise a panel assembly; and a cover coupled to the panel assembly. The panel assembly may comprise a heater coupled to a generally rigid structural layer. The heater may comprise at least one connector. The cover may comprise a textured surface configured to provide a generally planar outer surface for the component.

As shown schematically according to an exemplary embodiment in FIGS. 12A-12H, a vehicle interior component assembly may comprise a subsystem element in a formed body having a shape produced in a mold tool by a process comprising the steps of placing a subsystem element into the mold tool and molding the formed body in the mold tool with the subsystem element and the shape. The subsystem element may comprise a component configured to be electrified. The subsystem element may be at least partially concealed within the formed body. The formed body may comprise a molded body. The subsystem element may be molded into the molded body. The component assembly may comprise a cover. The cover may comprise a surface texture. The component assembly may comprise a structural member. The process may comprise the step of applying an adhesive for the subsystem element. The process may comprise the step of applying a paint. The process may comprise the step of applying a cover. The formed body may be formed as a plastic material. The formed body may be formed from resin. The mold tool may comprise a textured surface and the formed body may be formed from resin with a textured surface. The subsystem element may comprise a heating element and the formed body may be formed from resin to encapsulate the heating element. The heating element may comprise an electric heating element providing at least one wire configured to be exposed from the formed body for connection to the electric heating element. The subsystem element may comprise a heater.

As shown schematically according to an exemplary embodiment in FIGS. 12A-12H, a vehicle interior component may be prepared by a process comprising disposing a heater onto a first surface of a mold and injecting a resin into the mold between the heater and a second surface of the mold to form a panel assembly having a shape. The shape may correspond to a first contour of the first surface and a second contour of the second surface. The first surface of the mold may comprise a texture configured to form a textured surface of the heater. The process may comprise the step of disposing a cover onto the panel assembly to form the vehicle interior component. The heater may comprise at least one wire; the textured surface of the heater may be configured to provide a generally planar surface to the cover.

As shown schematically according to an exemplary embodiment in FIGS. 12A-12H, a component for a vehicle interior may comprise a panel assembly and a cover coupled to the panel assembly. The panel assembly may comprise a heater coupled to a generally rigid structural layer. The heater may comprise at least one connector. The cover may comprise a textured surface configured to provide a generally planar outer surface for the component. The panel assembly may be formed by molding a resin on the heater in a tool. The tool may comprise a surface configured to form a textured surface on the heater. The cover may be coupled to the heater. The cover may comprise at least one of (a) paint; (b) leather; (c) artificial leather; (d) vinyl; (e) woven fabric, (f) non-woven fabric, (g) an applique, (h) foil. The connector may comprise a wire.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

What is claimed is:

1. A vehicle interior component assembly comprising a heating element produced in a mold tool by a process comprising the steps of:
assembling the heating element between a cover layer and a fiber layer to provide a pre-form assembly;
consolidating the pre-form assembly;
placing the pre-form assembly into the mold tool;
forming the pre-form assembly into a compression-formed body with a shape;
applying a cover to the compression-formed body to provide a compression-formed panel;
so that the compression-formed panel is provided with the shape and an external surface provided by the cover.

2. The component assembly of claim 1 wherein the mold tool comprises a surface; wherein the external surface of the compression-formed panel is at least partially provided by the surface of the mold tool.

3. The component assembly of claim 1 wherein the step of consolidating the pre-form assembly comprises at least one of (a) securing the heating element between the cover layer and the fiber layer with adhesive; (b) merging the cover layer, the heating element and the fiber layer; (c) fusing the cover layer, the heating element and the fiber layer; (d) shaping the cover layer, the heating element and the fiber layer; (e) cutting the cover layer, the heating element and the fiber layer to size; (f) heating the cover layer, the heating element and/or the fiber layer.

4. The component assembly of claim 1 wherein the cover layer is configured for application of the cover; so that the cover is secured to the cover layer to provide the compression-formed panel with the external surface.

5. The component assembly of claim 1 wherein the external surface of the cover of the compression-formed panel is configured to provide a texture provided by the cover and the cover layer.

6. The component assembly of claim 1 wherein the fiber layer of the pre-form assembly comprises a structural layer; wherein the structural layer comprises natural fibers and a resin; wherein the cover layer comprises polypropylene and polyester.

7. The component assembly of claim 1 wherein the fiber layer comprises at least one of (a) a panel; (b) a mat; (c) a batt; (d) a fiber panel; (e) a fiber mat; (f) a fiber batt; (g) a natural fiber material; (h) a polypropylene material; (i) a natural fiber and polypropylene mat; (j) a mat formed from natural fibers and polypropylene fibers.

8. The component assembly of claim 1 wherein the cover layer for the pre-form assembly comprises at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet.

9. A component comprising an external surface for a vehicle interior comprising:
a panel assembly; and
a cover configured to provide the external surface;
wherein the panel assembly comprises a structural layer, a heater over the structural layer and a top layer between the heater and the cover.

10. The component of claim 9 wherein the top layer is configured to provide the external surface for the component comprising reduced variation.

11. The component of claim 9 wherein the top layer comprises an outer surface facing the cover with a smooth texture and the structural layer comprises an outer surface facing the heater with a rough texture.

12. The component of claim 9 wherein the top layer is configured to provide improved profile tolerance for the component.

13. The component of claim 9 wherein the top layer is configured to reduce variation in profile for the component.

14. The component of claim 9 wherein the top layer comprises at least one of (a) a fabric; (b) a non-woven fabric; (c) a synthetic fabric; (d) a thermoplastic fabric; (e) a non-woven fiber fabric; (f) flax; (g) a fiber mat; (h) a fiber mat comprising a fabric material; (i) a fabric sheet.

15. The component of claim 9 wherein the structural layer comprises natural fibers and a resin; wherein the top layer comprises polypropylene and polyester.

16. The component of claim 9 wherein the structural layer comprises at least one of (a) a panel; (b) a mat; (c) a batt; (d) a fiber panel; (e) a fiber mat; (f) a fiber batt.

17. The component of claim 9 wherein the cover comprises at least one of (a) leather; (b) artificial leather; (c) woven fabric; (d) non-woven fabric; (e) an applique; (f) vinyl; (g) foil.

18. The component of claim 9 wherein the heater comprises a substrate and a wire coupled to the substrate of the heater; wherein the substrate of the heater comprises polypropylene fibers; wherein the polypropylene fibers are bonded to at least one of (a) the top layer; (b) the structural layer.

19. The component of claim 9 produced by a process comprising the steps of:
assembling the heater between the top layer and the structural layer to provide a pre-form assembly;
consolidating the pre-form assembly;
placing the pre-form assembly into a mold tool;
forming the pre-form assembly into a compression-formed body with a shape;
applying the cover to the compression-formed body to provide a compression-formed panel;
so that the compression-formed panel is provided with the shape and an external surface provided by the cover.

20. A vehicle interior component assembly comprising a heating element produced in a mold tool by a process comprising the steps of:
assembling the heating element between a cover layer and a fiber layer;
consolidating the heating element, the cover layer and the fiber layer to provide a pre-form assembly by at least partially compressing the cover layer and the heating element and the fiber layer;
placing the pre-form assembly into the mold tool;
forming the pre-form assembly into a compression-formed body with a shape;
applying a cover to the compression-formed body to provide a compression-formed panel;
so that the compression-formed panel is provided with the shape and an external surface provided by the cover.
